(19) United States
(12) Patent Application Publication
(10) Pub. No.: US 2025/0171301 A1
(43) Pub. Date: May 29, 2025

(54) DEVICE AND METHOD FOR THE PYROLYSIS OF HYDROGEN-CONTAINING COMPOUNDS

(71) Applicant: BURCKHARDT COMPRESSION AG, Winterthur (CH)

(72) Inventor: Thorsten HARDER, Winterthur (CH)

(73) Assignee: BURCKHARDT COMPRESSION AG, Winterthur (CH)

(21) Appl. No.: 18/843,002

(22) PCT Filed: Mar. 1, 2023
(86) PCT No.: PCT/EP2023/055067

§ 371 Date: Aug. 30, 2024

(30) Foreign Application Priority Data
Mar. 1, 2022 (EP) 22159519.2

(51) Int. Cl. C01B 3/24; B01J 6/00; B01J 10/00; C01B 3/50; C01B 32/05

(52) U.S. Cl. CPC C01B 3/24; B01J 6/008; B01J 10/005; C01B 3/50; C01B 32/05; C01B 2203/0272; C01B 2203/04; C01B 2203/043; C01B 2203/0833; C01B 2203/148

(57) ABSTRACT

A device for producing hydrogen (H₂) and solid carbon by thermal decomposition of a feed gas (Z) containing hydrocarbons, including a pyrolysis reactor with a reaction chamber and a collecting chamber, the reaction chamber containing a liquid high-temperature heat transfer medium; a reactor feed line opening into the reaction chamber; a feed for the feed gas, the feed connected to the reactor feed line; a heating device for supplying heat to the reaction chamber; a discharge device in the collecting chamber for discharging a mixture of substances(S) from the collecting chamber; a separation device outside the pyrolysis reactor, the discharge device connected to the separation device via a discharge line, the separation device for separating the mixture of substances into at least the components solid carbon and hydrogen (H₂) or a gas mixture containing hydrogen (H₂); and a compressor for compressing the fluid supplied to the reactor feed line.

The invention relates to a device and a process for the pyrolysis of hydrogen-containing compounds.

In order to achieve the climate protection targets, technological solutions are of particular interest, which continue to allow the use of fossil resources while avoiding CO₂ emissions. One promising technical solution enables the decarbonization of hydrogen-containing compounds, in particular hydrocarbons such as natural gas or methane, by converting the hydrogen-containing compound into at least pure solid carbon and hydrogen using a cracking/pyrolysis reaction. In the case of methane, the basic formula is as follows:

CH₄→C+2H₂
with ΔH=74.5 kJ/mol

Temperatures of over 500° C. are required to carry out this reaction, whereby the energy input is capable of breaking the strong molecular C—H bonds (437 KJ/mol). Experimental analyses have shown that reaction rates of over 95% can be achieved under thermodynamic equilibrium conditions at temperatures of up to 1100° C.

Document WO 2019/154732A1 discloses a process and a device for the pyrolysis of hydrogen-containing compounds using a liquid metal reactor. This known process or this known device is only suitable to a limited extent for the continuous processing of hydrogen-containing compounds on an industrial scale. There is therefore a need for further improvement of the reaction control in the production of hydrogen by means of methane pyrolysis.

The object of the invention is to provide a more advantageous device or process for producing hydrogen from a hydrogen-containing compound, in particular from methane.

This problem is solved with a device having the features of claim 1. The dependent claims relate to further advantageous embodiments of the device. The problem is further solved by a process having the features of claim 13. The dependent claims relate to further advantageous process steps.

The problem is solved in particular with a device for the production of hydrogen and solid carbon by thermal decomposition of a feed gas containing hydrocarbons, comprising a pyrolysis reactor with a reaction chamber and a collecting chamber arranged above the reaction chamber, the reaction chamber containing a liquid high-temperature heat transfer medium, and comprising a reactor feed line opening into the reaction chamber, and comprising a feed for the feed gas, the feed being connected in a fluid-conducting manner to the reactor feed line, and comprising a heating device for supplying heat to the reaction chamber, and comprising a discharge device arranged in the collecting chamber for discharging a mixture of substances from the collecting chamber, and comprising a separation device arranged outside the pyrolysis reactor, the discharge device being connected to the separation device via a discharge line, and the separation device being designed for separating the mixture of substances into at least the components solid carbon and hydrogen, or solid carbon and a gas mixture containing hydrogen, and comprising a compressor for compressing the fluid fed to the reactor feed line.

The problem is further solved in particular with a process for the direct thermal decomposition of a hydrogen-containing compound into solid carbon and hydrogen by compressing a feed gas containing hydrocarbons, subsequently passing the compressed feed gas through a liquid high-temperature heat transfer medium and converting the feed gas in the high-temperature heat transfer medium into a mixture of substances, the mixture of substances is collected above the high-temperature heat carrier in a collecting chamber, the mixture of substances comprising at least the solid carbon and a gas mixture containing hydrogen, the mixture of substances is fed to a separation device downstream of the collecting chamber and the mixture of substances is depleted of solid carbon in the separation device, and the depleted mixture of substances and the solid carbon are discharged separately from the separation device.

The device or process according to the invention makes it possible to convert a hydrocarbon gas, preferably methane, into hydrogen and carbon on an industrial scale.

For the purposes of the present invention, the term “pyrolysis” is to be understood as the thermal decomposition of hydrocarbons, for example methane, in an oxygen-free atmosphere.

In the device according to the invention, it is provided that the pyrolysis reactor comprises a liquid metal reactor with a reaction chamber and a collecting chamber arranged above the reaction chamber, wherein the reaction chamber is designed to receive the liquid high-temperature heat transfer medium. The liquid metal reactor comprises an inlet for a feed gas or a reaction gas, the reaction gas preferably being introduced into the liquid metal reactor from below, the liquid metal reactor preferably having a porous section or a series of openings arranged along the lower part of the liquid metal reactor, to supply the reaction gas to the liquid metal reactor from below distributed over the inner cross-sectional area, preferably substantially uniformly distributed, so that the supplied reaction gas flows through the liquid high-temperature heat transfer medium located in the liquid metal reactor and thereby rises in the direction towards the collecting chamber.

For the purposes of the present invention, the term “high-temperature heat transfer medium” is to be understood as a heat transfer medium with high thermal stability. Preferably, the high-temperature heat transfer medium is a molten metal or molten salt. Metal melts are preferred. The good heat transfer of the molten metal to the reaction gas is particularly advantageous. Another advantage is the possibility of carbon separation due to the differences in density between the molten metal and carbon. The molten metal is preferably a metal or a metal alloy. A suitable molten metal is preferably selected from the group comprising lead-tin solders, lead-free solders, tin and/or magnesium. Lead-tin solders have low melting points and therefore allow the formation of a homogeneous molten metal at temperatures of around 200° C. For example, seepage solder with a composition of 63% tin and 37% lead and a eutectic point at 183° C. is such a well-suited lead-tin solder.

In the context of the invention, the high-temperature heat transfer medium is preferably not circulated. Particularly preferably, the high-temperature heat transfer medium is kept stationary; it is particularly preferably located only in the reaction chamber.

Further preferred is the use of catalytic additives to the high-temperature heat transfer medium, in particular to a molten metal, for example additives of bismuth, copper/nickel or copper/silver. By using catalytic additives to a molten metal, the reaction temperature can be lowered or the reaction conversion increased. Furthermore, enriching the molten metal with the carbon particles formed can also have an autocatalytic effect. The conversion can be further increased by an additional catalytic effect of the molten metal.

In the process for generating hydrogen by thermal decomposition of a hydrogen-containing compound in the pyrolysis reactor, the hydrogen-containing compound supplied as reaction gas is brought into contact with the liquid high-temperature heat transfer medium, whereby the residence time of the reaction gas in the liquid high-temperature heat transfer medium is preferably adjustable.

Pyrolysis, in which the reaction gas is brought into contact with a liquid high-temperature heat transfer medium, has the advantage of good heat transfer from the molten metal to the reaction gas. The liquid high-temperature heat transfer medium, for example a melt, is movable and allows a through-flow, so that the gaseous hydrogen-containing compound, for example methane, moves in an upward motion through the melt and ensures a constant renewal of the surface through this movement. The possibility of controlling the pressure and/or the amount of reaction gas supplied in the process according to the invention allows the convective heat input to be controlled or influenced in a controlled manner. The residence time of the gaseous hydrogen-containing compound in the liquid high-temperature heat transfer medium can be adjusted via the pressure of the supplied reaction gas and/or the quantity of the supplied reaction gas and/or the pressure present in the collecting chamber. Increasing the residence time has the advantage of significantly increasing the conversion of the thermal decomposition.

In a preferred embodiment, the pressure and/or the flow rate is adjusted with the aid of a compressor and/or with the aid of controllable valves. It may also prove advantageous to supply inert gases such as nitrogen or argon to the pyrolysis reactor to control the reaction.

The flow rate of the reaction gas in the high-temperature heat transfer medium can preferably be set via the pressure difference between the pressure of the reaction gas fed into the reaction chamber and the pressure in the collection chamber. It is also possible to adjust the height of the reaction chamber or the filling level of the liquid high-temperature heat transfer medium or to design it in such a way that a desired flow rate of the reaction gas in the melt is achieved. In preferred embodiments, the residence time of the gaseous hydrogen-containing compound in the liquid high-temperature heat transfer medium is in the range from 0.01 s to 1000 s, preferably in the range from 0.1 s to 100 s, and preferably in the range from 0.2 s to 10 s.

In preferred embodiments, the decomposition of the hydrogen-containing compound takes place at a temperature in the range from 500° C. to 1500° C., preferably in the range from 900° C. to 1400° C., and preferably in the range from 1000° C. to 1200° C. Decomposition of the gas at a temperature of approximately 500° C. is made possible, for example, if the melt is catalytically active.

The required reaction heat is conveniently supplied by burning a small proportion of the hydrogen produced or of another fuel. Electrical heating of the reaction chamber can also be provided.

Preferred hydrogen-containing compounds are selected from the group comprising methane, ethane, higher hydrocarbons, hydrogen sulfide, ammonia and/or mixtures thereof. For the purposes of the present invention, the term “higher hydrocarbons” is to be understood as hydrocarbons from propane onwards, in particular alkanes and mixtures thereof. Suitable hydrocarbon mixtures are, for example, crude biogas or crude natural gas mixtures. Liquid hydrocarbons, such as oil, can also be used without further ado. Liquid hydrocarbons can be rapidly vaporized at the prevailing reaction temperatures. Preferred hydrogen-containing compounds are gaseous hydrogen-containing compounds at ambient temperature, in particular selected from the group comprising methane, ethane, hydrogen sulphide, ammonia and/or mixtures thereof. Methane is a particularly preferred hydrogen-containing gas.

The device according to the invention allows pyrolysis by converting a hydrocarbon such as methane to hydrogen and carbon without producing environmentally harmful carbon dioxide. The carbon separated in the process is deposited above the high-temperature heat transfer medium, e.g. the molten metal, and is thus initially located in the collecting chamber as part of a mixture of substances comprising at least hydrogen and carbon. In the process according to the invention, the mixture of substances comprising the carbon is removed from the collecting chamber and fed to an external separation device downstream of the pyrolysis reactor, in which the mixture of substances is separated at least into carbon and a residual gas. The separation device preferably comprises a degassing container, which is designed as a pressure vessel. Advantageously, an additional conveying gas is supplied to the collection chamber, which in particular has the task of supporting the discharge of the carbon from the collection chamber. Preferably, the pressure and/or the quantity and/or the flow rate and/or the point of action of the conveying gas is controlled in order to act on the carbon inside the collection chamber in such a way that the carbon, which preferably forms continuously on the surface, can be reliably removed from the collection chamber and preferably conveyed to the downstream separation device. It may prove advantageous to provide an additional, preferably controllable compressor and/or a controllable valve in order to control the pressure and/or the quantity of the conveying gas supplied to the collection chamber.

The invention is described in detail below with reference to several embodiments.

The drawings used to illustrate the embodiments show:

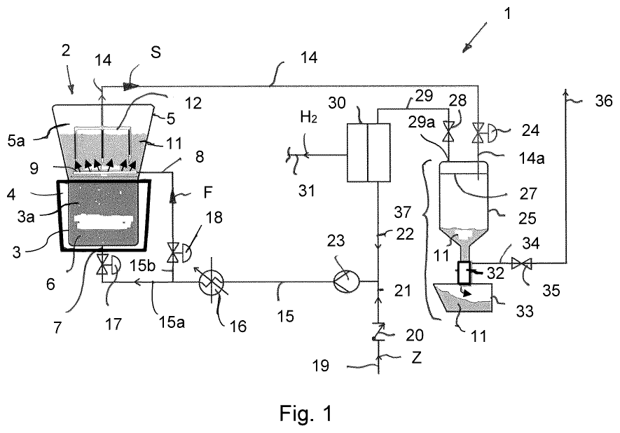

FIG. 1 a schematic representation of a device of a first embodiment for the pyrolysis of hydrogen-containing compounds;

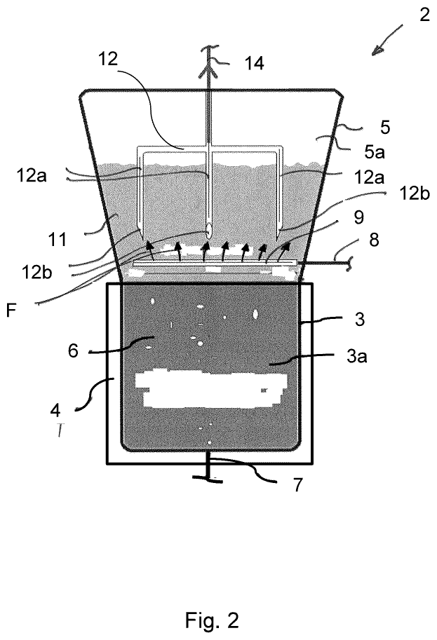

FIG. 2 a pyrolysis reactor in detail;

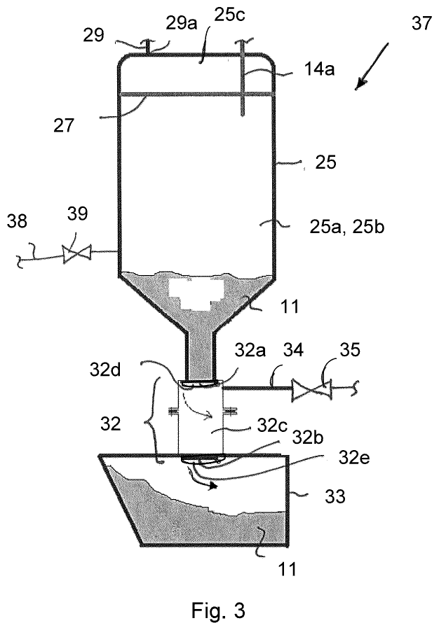

FIG. 3 a separating device in detail;

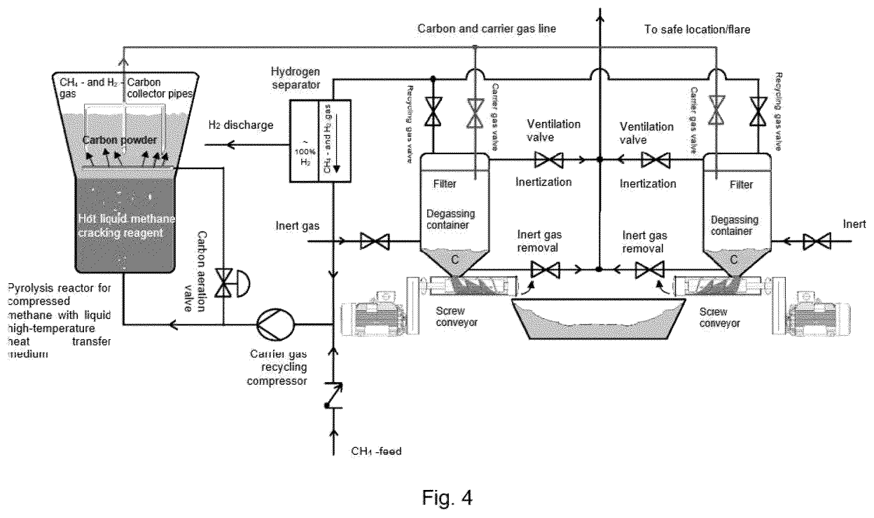

FIG. 4 a second example of a device for producing hydrogen and solid carbon.

Generally, identical parts are marked with identical reference symbols in the drawings.

FIG. 1 shows a device 1 for producing hydrogen H₂ and solid carbon 11 by thermal decomposition of a feed gas Z containing hydrocarbons. The device 1 comprises a pyrolysis reactor 2 with a reaction vessel 3 comprising a reaction chamber 3a and with a collecting vessel 5 arranged above the reaction chamber 3a and comprising a collecting chamber 5a. The reaction chamber 3a is at least partially filled with a liquid high-temperature heat transfer medium 6. A reactor feed line 7 leads into the reaction vessel 3 or into the reaction chamber 3a. An inlet 19 for the feed gas Z is connected to the reactor feed line 7 in a fluid-conducting manner. A heating device 4 is arranged at the reaction vessel 3 in order to supply heat to it and thus to the reaction chamber 3a. A discharge device 12 arranged in the collecting chamber 5a serves to discharge a mixture of substances S from the collecting chamber 5a of the collecting vessel 5. A separation device 37 arranged outside the pyrolysis reactor 2 and downstream of the pyrolysis reactor 2 in the direction of flow of the material mixture S is connected to the collecting chamber 5a via the discharge device 12 and the discharge line 14, so that the material mixture S located in the collecting chamber 5a, and in particular the carbon 11 located in the collecting chamber 5a, can be fed to the separation device 37, and preferably can be fed automatically. The separation device 37 is designed to separate the material mixture S into at least the components solid carbon 11 and hydrogen H₂, or into the components solid carbon 11 and a gas mixture containing hydrogen H₂. The device 1 also comprises a compressor 23 for compressing the fluid supplied to the reactor feed line 7.

FIG. 2 shows an enlarged view of the pyrolysis reactor 2 shown in FIG. 1. The discharge device 12 has the particular purpose of ensuring that the material mixture S located within the collection chamber 5a, and in particular the carbon 11, is reliably and preferably continuously conveyed out of the collection chamber 5a. In an advantageous embodiment, the discharge device 12 comprises a plurality of collecting pipes 12a with inlet openings 12b, which are arranged in the collecting chamber 5a. Advantageously, the collecting pipes 12a are lance-shaped, with inlet openings 12b directed towards the reaction chamber 3a. In a particularly advantageous embodiment, a gas supply line 8 opens into the collection chamber 5a, the purpose of which is in particular to support the discharge of the carbon 11 from the collection chamber 5a. In a particularly advantageous embodiment, a gas distribution device 9 is arranged within the collection chamber 5a between the reaction chamber 3a and the inlet openings 12b of the discharge device 12, to which a conveying gas F is fed from the gas supply line 8 in order to preferably loosen up the carbon 11 present in the collection chamber 5a by means of the inflowing conveying gas F and to feed it to the inlet openings 12.

As can be seen from FIG. 1, a compressor 23 is advantageously provided to compress at least the feed gas Z supplied via the feed 19. The reactor supply line 7 and preferably also the feed gas supply line 8 are arranged downstream of the compressor in the direction of flow of the supplied fluid. A supply line 15, 15a, 15b is preferably arranged between the compressor 23 and the reactor supply line 7 and/or the feed gas supply line 8, which can also be routed through a preheater 16, for example. A first and/or a second valve 17, 18 can also be provided, which can preferably be controlled by a control device not shown, for example to control the pressure or the delivery rate of the feed gas Z fed into the reaction chamber 3a, and/or to control the pressure or the delivery rate of the feed gas F fed into the collecting chamber 5a. It may prove advantageous to change the pressure of the feed gas 5 intermittently, for example by periodically switching the feed gas flow on and off during a predetermined period of time, or by a sequence of pressure fluctuations of the feed gas flow by a corresponding switching of the valve 18, in order thereby in particular to swirl up the carbon 11 located in the collecting chamber 5a and thereby support the discharge of the carbon 11 from the collecting chamber 5a. It may also prove advantageous to connect an additional, preferably controllable compressor to the feed lines 15a, 15b in order to influence and in particular control the pressure difference of the gas between the feed line into the reaction vessel 3 and the collection chamber 5a.

In the degassing vessel 25 arranged downstream of the pyrolysis reactor 2, the carbon 11 is preferably separated from the supplied material mixture S under pressure. As shown in FIG. 1, the separation device 37 comprises a degassing vessel 25, which is designed as a pressurized vessel, wherein degassing vessel 25 comprises a degassing vessel interior space 25a with a lower partial interior space 25b and an upper partial interior space 25c. The lower partial interior space 25b opens into an airlock 32 for discharging the preferably pulverized carbon 11. A particle filter 27 is advantageously arranged in the degassing container interior space 25a, which divides the degassing container interior space 25a into the lower partial interior space 25b and the upper partial interior space 25c, in that the discharge line 14 opens into the lower partial interior space 25b via a supply line 14a, a gas outlet 29a arranged in the upper partial interior space 25c feeding a gas discharge line 29. In addition, controllable valves 24, 28 can be provided. The gas outlet 29 preferably opens into a hydrogen separation device 30, which at least partially removes hydrogen from the supplied fluid and feeds it to a hydrogen discharge 31. The hydrogen separation device 30 preferably comprises a device for pressure swing adsorption (PSA) or a membrane for depleting the hydrogen. The outlet of the hydrogen separation device 30 could be discharged to the environment. The fluid depleted of hydrogen in the hydrogen separation device 30 is preferably fed to the pyrolysis reactor 2. Particularly preferably, the hydrogen-depleted fluid is recycled as a second gas feed 22 and preferably fed to the reaction vessel 3, advantageously by feeding the feed gas Z to the compressor 32 via the feed 19 and a first gas feed 21 together with the second gas feed 22. Advantageously, an inlet valve 20 is also provided between the first gas supply 21 and the feed 19. The hydrogen-depleted fluid could, starting from the hydrogen separation device 30, also be fed to a separate compressor, not shown, and the hydrogen-depleted fluid compressed in this way could advantageously be fed directly to the collecting chamber 5a via the second feed gas supply line 8.

FIG. 3 shows the separation device 37 and in particular the airlock 32 in detail. The airlock 32 comprises a first closable opening 32a, an intermediate space 32c and a second closable opening 32b, wherein these openings 32a, 32b can each be opened and closed in a controllable manner with a first or second pivotable cover 32d, 32e, so that the carbon 11 located in the lower region of the degassing container 25 can be fed to the storage container 33 and the pressure present inside the degassing container 25 can nevertheless be maintained. The intermediate space 32c is preferably provided with a pressure relief and has, for example, a drain 34 and a valve 35 arranged downstream. It may also prove advantageous to provide an inert gas feed 38 and a valve 39, in particular to feed the carbon 11 to the airlock 32 with the aid of the inert gas supplied via the inert gas feed 38. Nitrogen or carbon dioxide, for example, is suitable as inert gas.

The process according to the invention for the direct thermal decomposition of a hydrogen-containing compound into solid carbon 11 and hydrogen H₂ is carried out in such a way that a feed gas Z containing hydrocarbons is compressed, the compressed feed gas Z is then passed through a liquid high-temperature heat transfer medium 6 and the feed gas Z is converted into a mixture of substances S in the high-temperature heat transfer medium 6, the mixture of substances S is collected above the high-temperature heat transfer medium 6 in a collecting chamber 5a, wherein the material mixture S comprises at least the solid carbon 11 and a gas mixture containing hydrogen H₂, the material mixture S is fed to a separation device 37 arranged downstream of the collecting chamber 5a and the material mixture S is depleted of solid carbon 11 in the separation device 37, wherein the depleted material mixture S and the solid carbon 11 are discharged separately from the separation device 37.

Preferably, hydrogen H₂ is subsequently depleted from the discharged, depleted mixture of substances S, with the mixture of substances S depleted of hydrogen H₂ preferably being fed to the pyrolysis reactor 2, and in particular to the liquid high-temperature heat transfer medium 6 located therein.

Preferably, the hydrogen H₂ depleted material mixture S is compressed before it is then fed to the liquid high-temperature heat transfer medium 6.

Preferably, a conveying gas F is fed to the material mixture S accumulating in the collecting chamber 5a in such a way that at least some of the solid carbon 11 present in the collecting chamber 5a is fed to the separation device 37 by the acting conveying gas F. Preferably, the pressure, the delivery rate and/or the point of action of the conveying gas F flowing into the collection chamber 5a is changed or modulated in time, and the solid carbon 11 located in the collection chamber 5a is thereby stirred up in order to support the supply of the carbon into the discharge device 12 in this way.

1. A device for the production of hydrogen (H₂) and solid carbon by thermal decomposition of a feed gas containing hydrocarbons, comprising:
a pyrolysis reactor with a reaction chamber and a collecting chamber arranged above the reaction chamber, wherein the reaction chamber contains a liquid high-temperature heat transfer medium;
a reactor feed line opening into the reaction chamber;
a feed for the feed gas (Z), the feed being connected in a fluid-conducting manner to the reactor feed line;
a heating device for supplying heat to the reaction chamber;
a discharge device arranged in the collecting chamber for discharging a mixture of substances (S) from the collecting chamber;
a separation device arranged outside the pyrolysis reactor, the discharge device being connected to the separation device via a discharge line, and the separation device being designed for separating the mixture of substances (S) into at least the components solid carbon and hydrogen (H₂) or a gas mixture containing hydrogen (H₂); and
a compressor for compressing the fluid supplied to the reactor feed line.

2. The device according to claim 1, wherein the high-temperature heat transfer medium is a molten metal or a molten salt.

3. The device according to claim 1, wherein the discharge device comprises a plurality of collecting pipes with inlet openings, which are arranged in the collecting chamber.

4. The device according to claim 3, wherein the collecting tubes are lance-shaped, with inlet openings directed towards the reaction chamber.

5. The device according to claim 1, wherein a gas supply line opens into the collecting chamber.

6. The device according to claim 5, wherein a gas distribution device, which is fed by the gas supply line, is arranged between the reaction chamber and the inlet openings of the discharge device.

7. The device according to claim 5, wherein the reactor supply line and the gas supply line are arranged downstream of the compressor in a direction of flow of the supplied fluid.

8. The device according to claim 1, wherein the separation device comprises a degassing vessel which is designed as a pressure vessel.

9. The device according to claim 8, wherein the degassing vessel comprises a degassing vessel interior with a lower partial interior and an upper partial interior, the lower partial interior opening into an airlock for discharging the solid carbon (11), wherein a particle filter is arranged in the degassing container interior space, which divides the degassing container interior space into the lower partial interior space and the upper partial interior space, in that the discharge line opens into the lower partial interior space, and in that a gas outlet arranged in the upper partial interior space feeds a gas discharge line.

10. The device according to claim 9, wherein the gas outlet opens into a hydrogen separation device which at least partially depletes the supplied fluid of hydrogen.

11. The device according to claim 10, wherein the hydrogen-depleted fluid is fed to the pyrolysis reactor.

12. The device according to claim 11, wherein the hydrogen-depleted fluid is fed to the compressor starting from the hydrogen separation device.

13. A process for the direct thermal decomposition of a hydrogen-containing compound into solid carbon and hydrogen (H₂) by:
compressing a feed gas (Z) containing hydrocarbons;
subsequently passing the compressed feed gas (Z) through a liquid high-temperature heat transfer medium, and converting the feed gas (Z) in the high-temperature heat transfer medium into a mixture of substances (S);
collecting the mixture of substances (S) above the high-temperature heat transfer medium in a collecting chamber, the mixture of substances (S) comprising at least the solid carbon and a gas mixture containing hydrogen (H₂);
feeding the mixture of substances (S) to a separation device downstream of the collection chamber and depleting the mixture of substances (S) of solid carbon in the separation device (37); and
discharging the depleted material mixture (S) and the solid carbon separately from the separation device.

14. The process according to claim 13, wherein hydrogen (H₂) is subsequently depleted from the discharged, depleted mixture of substances (S), and in that the mixture of substances (S) depleted of hydrogen (H₂) is fed to the liquid high-temperature heat transfer medium.

15. The process according to claim 14, wherein the mixture of substances (S) depleted in hydrogen (H₂) is compressed and then fed to the liquid high-temperature heat transfer medium.

16. The process according to claim 13, wherein a conveying gas (F) is fed to the mixture of substances (S) accumulating in the collecting chamber in such a way that at least some of the solid carbon present in the collecting chamber is fed to the separation device by the acting conveying gas (F).

17. The process according to claim 16, wherein a parameter selected from the group consisting of a pressure, a delivery rate and a point of action of the delivery gas (F) flowing into the collecting chamber is changed over time, and the solid carbon located in the collecting chamber is thereby stirred up.
